(19) United States
(12) Patent Application Publication
(10) Pub. No.: US 2002/0099544 A1
(43) Pub. Date: Jul. 25, 2002

(54) System, method and computer program product for damage control during large-scale address speech recognition

(76) Inventors: Benjamin J. Levitt, Mountain View, CA (US); Bertrand A. Damiba, Sunnyvale, CA (US)

Correspondence Address: SILICON VALLEY INTELLECTUAL PROPERTY GROUP, P.O. BOX 721120, SAN JOSE, CA, 95172-1120, US

(21) Appl. No.: 09/894,164

(22) Filed: Jun. 26, 2001

Related U.S. Application Data
(63) Continuation-in-part of application No. 09/770,750, filed on Jan. 24, 2001.

(51) Int. Cl. G10L 15/00; G10L 17/00

(52) U.S. Cl. 704/247

(57) ABSTRACT

A system, method and computer program product are provided for recognizing utterances. Initially, an utterance is received including at least two components. Matches are identified between each of the components of the utterance and grammars. Each instance of a match of a first one of the components is then combined with each instance of a match of a second one of the components to generate a plurality of grammar expressions. In operation, the received utterance is recognized utilizing the grammar expressions.

### RELATED APPLICATIONS

The present application is a continuation-in-part of a co-pending U.S. application entitled “SYSTEM, METHOD AND COMPUTER PROGRAM PRODUCT FOR LARGE-SCALE STREET NAME SPEECH RECOGNITION” filed Jan. 24, 2001 under Ser. No. 09/770,750 which is incorporated herein by reference in its entirety.

### FIELD OF THE INVENTION

The present invention relates to speech recognition, and more particularly to large-scale speech recognition.

### BACKGROUND OF THE INVENTION

Techniques for accomplishing automatic speech recognition (ASR) are well known. Among known ASR techniques are those that use grammars. A grammar is a representation of the language or phrases expected to be used or spoken in a given context. In one sense, then, ASR grammars typically constrain the speech recognizer to a vocabulary that is a subset of the universe of potentially-spoken words; and grammars may include subgrammars. An ASR grammar rule can then be used to represent the set of “phrases” or combinations of words from one or more grammars or subgrammars that may be expected in a given context. “Grammar” may also refer generally to a statistical language model (where a model represents phrases), such as those used in language understanding systems.

Products and services that utilize some form of automatic speech recognition (“ASR”) methodology have been recently introduced commercially. Desirable attributes of complex ASR services that would utilize such ASR technology include high accuracy in recognition; robustness to enable recognition where speakers have differing accents or dialects, and/or in the presence of background noise; ability to handle large vocabularies; and natural language understanding. In order to achieve these attributes for complex ASR services, ASR techniques and engines typically require computer-based systems having significant processing capability in order to achieve the desired speech recognition capability.

One application of ASR techniques is the voice entry of addresses, i.e. street names, cities, etc. for the purpose of receiving directions. One example of such application is disclosed in U.S. Pat. No. 6,108,631. Such invention relates to an input system for at least location and/or street names, including an input device, a data source arrangement which contains at least one list of locations and/or streets, and a control device which is arranged to search location or street names, entered via the input device, in a list of locations or streets in the data source arrangement. In order to simplify the input of location and/or street names, the data source arrangement contains not only a first list of locations and/or streets with alphabetically sorted location and/or street names, but also a second list of locations and/or streets with location and/or street names sorted on the basis of a frequency criterion. A speech input system of the input device conducts input in the form of speech to the control device. The control device is arranged to perform a sequential search for a location or street name, entered in the form of speech, as from the beginning of the second list of locations and/or streets.

Such prior art direction services supply to a traveler automatically developed step-by-step directions for travel from a starting point to a destination. Typically these directions are a series of steps which detail, for the entire route, a) the particular series of streets or highways to be traveled, b) the nature and location of the entrances and exits to/from the streets and highways, e.g., turns to be made and exits to be taken, and c) optionally, travel distances and landmarks.

One difficulty that arises when attempting to identify and differentiate between the plethora of streets is the ability to accurately identify the street name corresponding to an utterance of a user. This problem is exacerbated as a result of the prevalent reuse of names, the varied pronunciations thereof, and the overall massive amount of street names in existence.

There is therefore a need for an improved technique of recognizing street names and the like.

### DISCLOSURE OF THE INVENTION

A system, method and computer program product are provided for recognizing utterances. Initially, an utterance is received including at least two components. Matches are identified between each of the components of the utterance and grammars. Each instance of a match of a first one of the components is then combined with each instance of a match of a second one of the components to generate a plurality of grammar expressions. In operation, the received utterance is recognized utilizing the grammar expressions.

In one embodiment of the present invention, duplicate grammar expressions may be discarded during the recognition process.

In operation, the grammar expressions may be played back to a user. As an option, a score may be assigned to each of the grammar expressions. As such, the grammar expressions may be prioritized and conditionally outputted to a user based on the score.

In another embodiment of the present invention, the utterance may be representative of at least a portion of an address. The components of the utterance may include a city and a state of the address and/or a street name and an address number of the address. Further, the components of the utterance may include two street names describing an intersection. As such, the results of the recognition may be compared with a database of addresses. Certain grammar expressions may then be discarded based on the comparison, and the remaining grammar expressions of grammars may be outputted.

A user is capable of rejecting the played back grammar expressions during the process of recognizing the grammar expressions. Such rejected grammar expressions may be discarded. In still another embodiment of the present invention, results of the aforementioned comparison between the recognition results and the database may be cached for use when recognizing subsequent utterances.

### BRIEF DESCRIPTION OF THE DRAWINGS

FIG. 1 illustrates an exemplary environment in which the present invention may be implemented;

FIG. 2 shows a representative hardware environment associated with the components of FIG. 1;

FIG. 3 is a schematic diagram showing one exemplary combination of databases that may be used for generating a collection of grammars;

FIG. 4 illustrates a gathering method for collecting a large number of grammars such as all of the street names in the United States of America using the combination of databases shown in FIG. 3;

FIG. 4A illustrates a pair of exemplary lists showing a plurality of streets names organized according to city;

FIG. 5 illustrates a method for recognizing utterances utilizing the database of grammars established in FIGS. 3 and 4; and

FIG. 5A illustrates a method for carrying out damage control when recognizing utterances in accordance with the method of FIG. 5.

### DESCRIPTION OF THE PREFERRED EMBODIMENTS

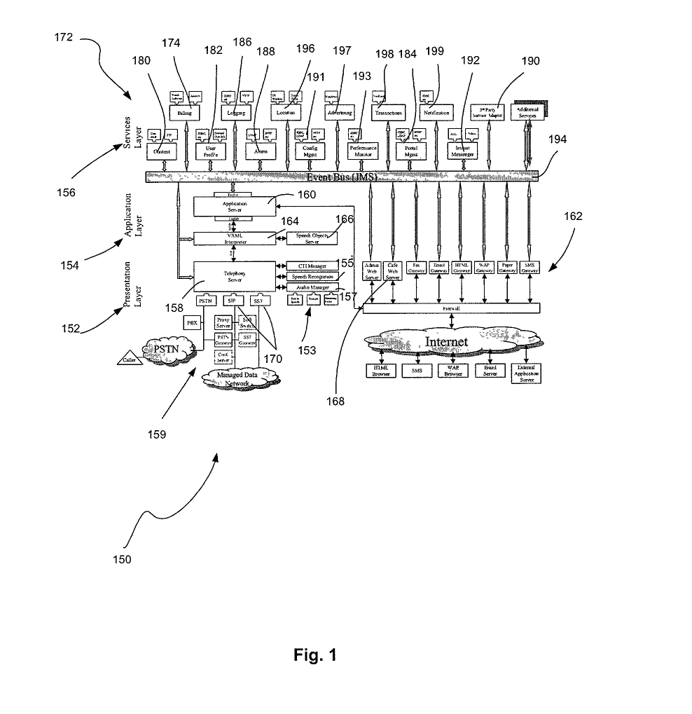

FIG. 1 illustrates one exemplary platform 150 on which the present invention may be implemented. The present platform 150 is capable of supporting voice applications that provide unique business services. Such voice applications may be adapted for consumer services or internal applications for employee productivity.

The present platform of FIG. 1 provides an end-to-end solution that manages a presentation layer 152, application logic 154, information access services 156, and telecom infrastructure 159. With the instant platform, customers can build complex voice applications through a suite of customized applications and a rich development tool set on an application server 160. The present platform 150 is capable of deploying applications in a reliable, scalable manner, and maintaining the entire system through monitoring tools.

The present platform 150 is multi-modal in that it facilitates information delivery via multiple mechanisms 162, i.e. Voice, Wireless Application Protocol (WAP), Hypertext Mark-up Language (HTML), Facsimile, Electronic Mail, Pager, and Short Message Service (SMS). It further includes a VoiceXML interpreter 164 that is fully compliant with the VoiceXML 1.0 specification, written entirely in Java®, and supports Nuance® SpeechObjects 166.

Yet another feature of the present platform 150 is its modular architecture, enabling “plug-and-play” capabilities. Still yet, the instant platform 150 is extensible in that developers can create their own custom services to extend the platform 150. For further versatility, Java® based components are supported that enable rapid development, reliability, and portability. Another web server 168 supports a web-based development environment that provides a comprehensive set of tools and resources which developers may need to create their own innovative speech applications.

Support for SIP and SS7 (Signaling System 7) is also provided. Backend Services 172 are also included that provide value added functionality such as content management 180 and user profile management 182. Still yet, there is support for external billing engines 174 and integration of leading edge technologies from Nuance®, Oracle®, Cisco®, Natural Microsystems®, and Sun Microsystems®.

More information will now be set forth regarding the application layer 154, presentation layer 152, and services layer 156.

Application Layer (154)

The application layer 154 provides a set of reusable application components as well as the software engine for their execution. Through this layer, applications benefit from a reliable, scalable, and high performing operating environment. The application server 160 automatically handles lower level details such as system management, communications, monitoring, scheduling, logging, and load balancing. Some optional features associated with each of the various components of the application layer 154 will now be set forth.

Application Server (160)

A high performance web/JSP server that hosts the business and presentation logic of applications.

High performance, load balanced, with failover.

Contains reusable application components and ready to use applications.

Hosts Java Servlets and JSP's for custom applications.

Provides easy to use taglib access to platform services.

VXML Interpreter (164)

Executes VXML applications

VXML 1.0 compliant

Can execute applications hosted on either side of the firewall.

Extensions for easy access to system services such as billing.

Extensible—allows installation of custom VXML tag libraries and speech objects.

Provides access to SpeechObjects 166 from VXML.

Integrated with debugging and monitoring tools.

Written in Java®.

Speech Objects Server (166)

Hosts SpeechObjects based components.

Provides a platform for running SpeechObjects based applications.

Contains a rich library of reusable SpeechObjects.

Services Layer (156)

The services layer 156 simplifies the development of voice applications by providing access to modular value-added services. These backend modules deliver a complete set of functionality, and handle low level processing such as error checking. Examples of services include the content 180, user profile 182, billing 174, and portal management 184 services. By this design, developers can create high performing, enterprise applications without complex programming. Some optional features associated with each of the various components of the services layer 156 will now be set forth.

Content (180)

Manages content feeds and databases such as weather reports, stock quotes, and sports.

Ensures content is received and processed appropriately.

Provides content only upon authenticated request.

Communicates with logging service 186 to track content usage for auditing purposes.

Supports multiple, redundant content feeds with automatic failover.

Sends alarms through alarm service 188.

User Profile (182)

Manages user database

Can connect to a 3^{rd} party user database 190. For example, if a customer wants to leverage his/her own user database, this service will manage the connection to the external user database.

Provides user information upon authenticated request.

Alarm (188)

Provides a simple, uniform way for system components to report a wide variety of alarms.

Allows for notification (Simply Network Management Protocol (SNMP), telephone, electronic mail, pager, facsimile, SMS, WAP push, etc.) based on alarm conditions.

Allows for alarm management (assignment, status tracking, etc) and integration with trouble ticketing and/or helpdesk systems.

Allows for integration of alarms into customer premise environments.

Configuration Management (191)

Maintains the configuration of the entire system.

Performance Monitor (193)

Provides real time monitoring of entire system such as number of simultaneous users per customer, number of users in a given application, and the uptime of the system.

Enables customers to determine performance of system at any instance.

Portal Management (184)

The portal management service 184 maintains information on the configuration of each voice portal and enables customers to electronically administer their voice portal through the administration web site.

Portals can be highly customized by choosing from multiple applications and voices. For example, a customer can configure different packages of applications i.e. a basic package consisting of 3 applications for $4.95, a deluxe package consisting of 10 applications for $9.95, and premium package consisting of any 20 applications for $14.95.

Instant Messenger (192)

Detects when users are “on-line” and can pass messages such as new voicemails and e-mails to these users.

Billing (174)

Provides billing infrastructure such as capturing and processing billable events, rating, and interfaces to external billing systems.

Logging (186)

Logs all events sent over the JMS bus 194. Examples include User A of Company ABC accessed Stock Quotes, application server 160 requested driving directions from content service 180, etc.

Location (196)

Provides geographic location of caller.

Location service sends a request to the wireless carrier or to a location network service provider such as TimesThree®or US Wireless. The network provider responds with the geographic location (accurate within 75 meters) of the cell phone caller.

Advertising (197)

Administers the insertion of advertisements within each call. The advertising service can deliver targeted ads based on user profile information.

Interfaces to external advertising services such as Wyndwire® are provided.

Transactions (198)

Provides transaction infrastructure such as shopping cart, tax and shipping calculations, and interfaces to external payment systems.

Notification (199)

Provides external and internal notifications based on a timer or on external events such as stock price movements. For example, a user can request that he/she receive a telephone call every day at 8 AM.

Services can request that they receive a notification to perform an action at a pre-determined time. For example, the content service 180 can request that it receive an instruction every night to archive old content.

3^{rd} Party Service Adapter (190)

Enables 3^{rd} parties to develop and use their own external services. For instance, if a customer wants to leverage a proprietary system, the 3^{rd} party service adapter can enable it as a service that is available to applications.

Presentation Layer (152)

The presentation layer 152 provides the mechanism for communicating with the end user. While the application layer 154 manages the application logic, the presentation layer 152 translates the core logic into a medium that a user's device can understand. Thus, the presentation layer 152 enables multi-modal support. For instance, end users can interact with the platform through a telephone, WAP session, HTML session, pager, SMS, facsimile, and electronic mail. Furthermore, as new “touchpoints” emerge, additional modules can seamlessly be integrated into the presentation layer 152 to support them.

Telephony Server (158)

The telephony server 158 provides the interface between the telephony world, both Voice over Internet Protocol (VoIP) and Public Switched Telephone Network (PSTN), and the applications running on the platform. It also provides the interface to speech recognition and synthesis engines 153. Through the telephony server 158, one can interface to other 3^{rd} party application servers 190 such as unified messaging and conferencing server. The telephony server 158 connects to the telephony switches and “handles” the phone call.

Features of the telephony server 158 include:

Mission critical reliability.

Suite of operations and maintenance tools.

Telephony connectivity via ISDN/T1/E1, SIP and SS7 protocols.

DSP-based telephony boards offload the host, providing real-time echo cancellation, DTMF & call progress detection, and audio compression/decompression.

Speech Recognition Server (155)

The speech recognition server 155 performs speech recognition on real time voice streams from the telephony server 158. The speech recognition server 155 may support the following features:

Carrier grade scalability & reliability

Large vocabulary size

Industry leading speaker independent recognition accuracy

Recognition enhancements for wireless and hands free callers

Dynamic grammar support—grammars can be added during run time.

Multi-language support

Barge in—enables users to interrupt voice applications. For example, if a user hears “Please say a name of a football team that you,” the user can interject by saying “Miami Dolphins” before the system finishes.

Speech objects provide easy to use reusable components

“On the fly” grammar updates

Speaker verification

Audio Manager (157)

Manages the prompt server, text-to-speech server, and streaming audio.

Prompt Server (153)

The Prompt server is responsible for caching and managing pre-recorded audio files for a pool of telephony servers.

Text-to-Speech Server (153)

When pre-recorded prompts are unavailable, the text-to-speech server is responsible for transforming text input into audio output that can be streamed to callers on the telephony server 158. The use of the TTS server offloads the telephony server 158 and allows pools of TTS resources to be shared across several telephony servers. Features include:

Support for industry leading technologies such as SpeechWorks® Speechify® and L&H RealSpeak®.

Standard Application Program Interface (API) for integration of other TTS engines.

Streaming Audio

The streaming audio server enables static and dynamic audio files to be played to the caller. For instance, a one minute audio news feed would be handled by the streaming audio server.

Support for standard static file formats such as WAV and MP3

Support for streaming (dynamic) file formats such as Real Audio® and Windows® Media®.

PSTN Connectivity

Support for standard telephony protocols like ISDN, E&M WinkStart®, and various flavors of E1 allow the telephony server 158 to connect to a PBX or local central office.

SIP Connectivity

The platform supports telephony signaling via the Session Initiation Protocol (SIP). The SIP signaling is independent of the audio stream, which is typically provided as a G.711 RTP stream. The use of a SIP enabled network can be used to provide many powerful features including:

Flexible call routing

Call forwarding

Blind & supervised transfers

Location/presence services

Interoperable with SIP compliant devices such as soft switches

Direct connectivity to SIP enabled carriers and networks

Connection to SS7 and standard telephony networks (via gateways)

Admin Web Server

Serves as the primary interface for customers.

Enables portal management services and provides billing and simple reporting information. It also permits customers to enter problem ticket orders, modify application content such as advertisements, and perform other value added functions.

Consists of a website with backend logic tied to the services and application layers. Access to the site is limited to those with a valid user id and password and to those coming from a registered IP address. Once logged in, customers are presented with a homepage that provides access to all available customer resources.

Other (168)

Web-based development environment that provides all the tools and resources developers need to create their own speech applications.

Provides a VoiceXML Interpreter that is:

Compliant with the VoiceXML 1.0 specification.

Compatible with compelling, location-relevant SpeechObjects—including grammars for nationwide US street addresses.

Provides unique tools that are critical to speech application development such as a vocal player. The vocal player addresses usability testing by giving developers convenient access to audio files of real user interactions with their speech applications. This provides an invaluable feedback loop for improving dialogue design.

WAP, HTML, SMS, Email, Pager, and Fax Gateways

Provide access to external browsing devices.

Manage (establish, maintain, and terminate) connections to external browsing and output devices.

Encapsulate the details of communicating with external device.

Support both input and output on media where appropriate. For instance, both input from and output to WAP devices.

Reliably deliver content and notifications.

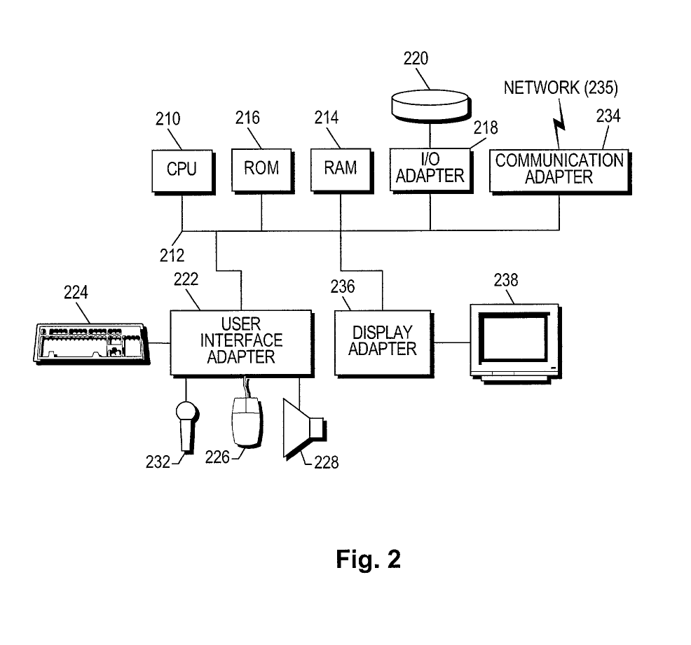

FIG. 2 shows a representative hardware environment associated with the various systems, i.e. computers, servers, etc., of FIG. 1. FIG. 2 illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network (e.g., a data processing network) and a display adapter 236 for connecting the bus 212 to a display device 238. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

Initially, a database must first be established with all of the necessary grammars. In one embodiment of the present invention, the database is populated with a multiplicity of street names for voice recognition purposes. In order to get the best coverage for all the street names, data from multiple data sources may be merged.

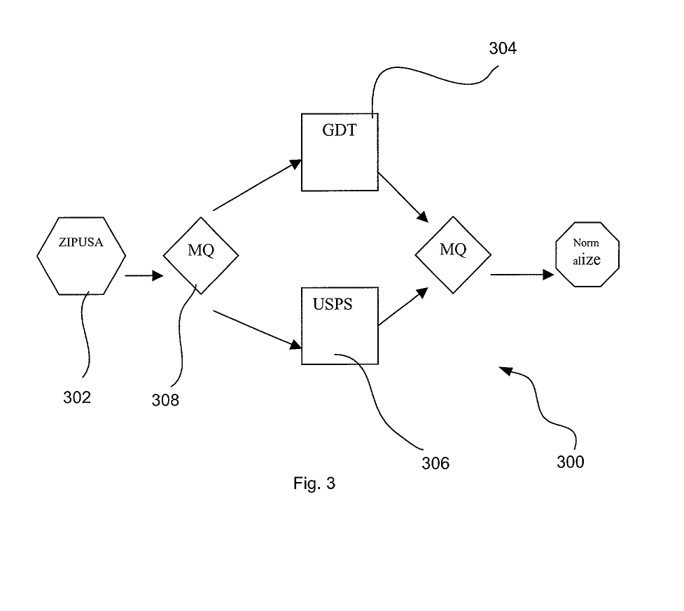

FIG. 3 is a schematic diagram showing one exemplary combination of databases 300. In the present embodiment, such databases may include a first database 302 including city names and associated zip codes (i.e. a ZIPUSA OR TPSNET database), a second database 304 including street names and zip codes (i.e. a Geographic Data Technology (GDT) database), and/or a United States Postal Services (USPS) database 306. In other embodiments, any other desired databases may be utilized. Further tools may also be utilized such as a server 308 capable of verifying street, city names, and zip codes.

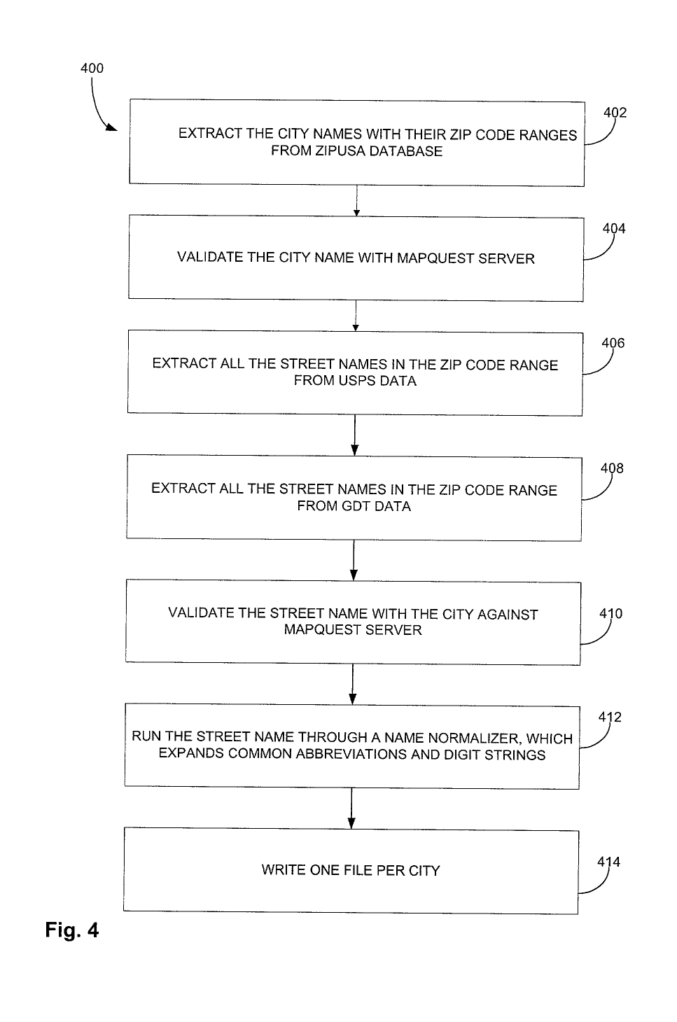

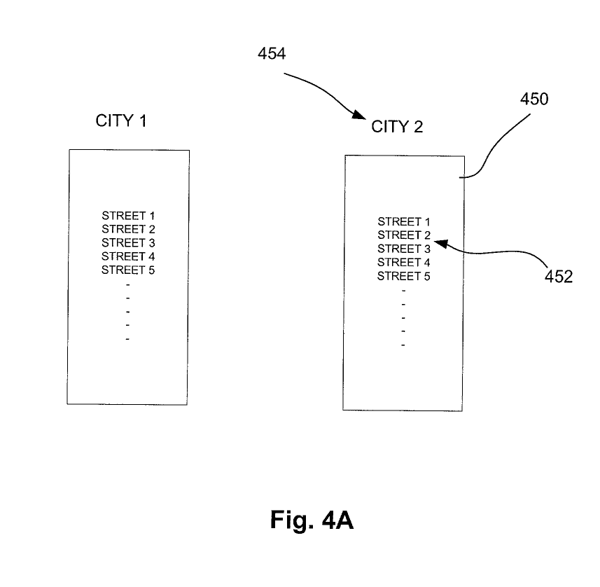

FIG. 4 illustrates a gathering method 400 for collecting a large number of grammars such as all of the street names in the United States of America using the combination of databases 300 shown in FIG. 3. As shown in FIG. 4, city names and associated zip code ranges are initially extracted from the ZIPUSA OR TPSNET database. Note operation 402. It is well known in the art that each city has a range of zip codes associated therewith. As an option, each city may further be identified using a state and/or county identifier. This may be necessary in the case where multiple cities exist with similar names.

Next, in operation 404, the city names are validated using a server capable of verifying street names, city names, and zip codes. In one embodiment, such server may take the form of a MapQuest server. This step is optional for ensuring the integrity of the data.

Thereafter, all of the street names in the zip code range are extracted from USPS data in operation 406. In a parallel process, the street names in the zip code range are similarly extracted from the GDT database. Note operation 408. Such street names are then organized in lists according to city. FIG. 4A illustrates a pair of exemplary lists 450 showing a plurality of streets names 452 organized according to city 454. Again, in operation 410, the street names are validated using the server capable of verifying street names, city names, and zip codes.

It should be noted that many of the databases set forth hereinabove utilize abbreviations. In operation 412, the street names are run through a name normalizer, which expands common abbreviations and digit strings. For example, the abbreviations “St.” and “Cr.” can be expanded to “street” and “circle,” respectively.

In operation 414, a file is generated for each city. Each of such files delineates each of the appropriate street names.

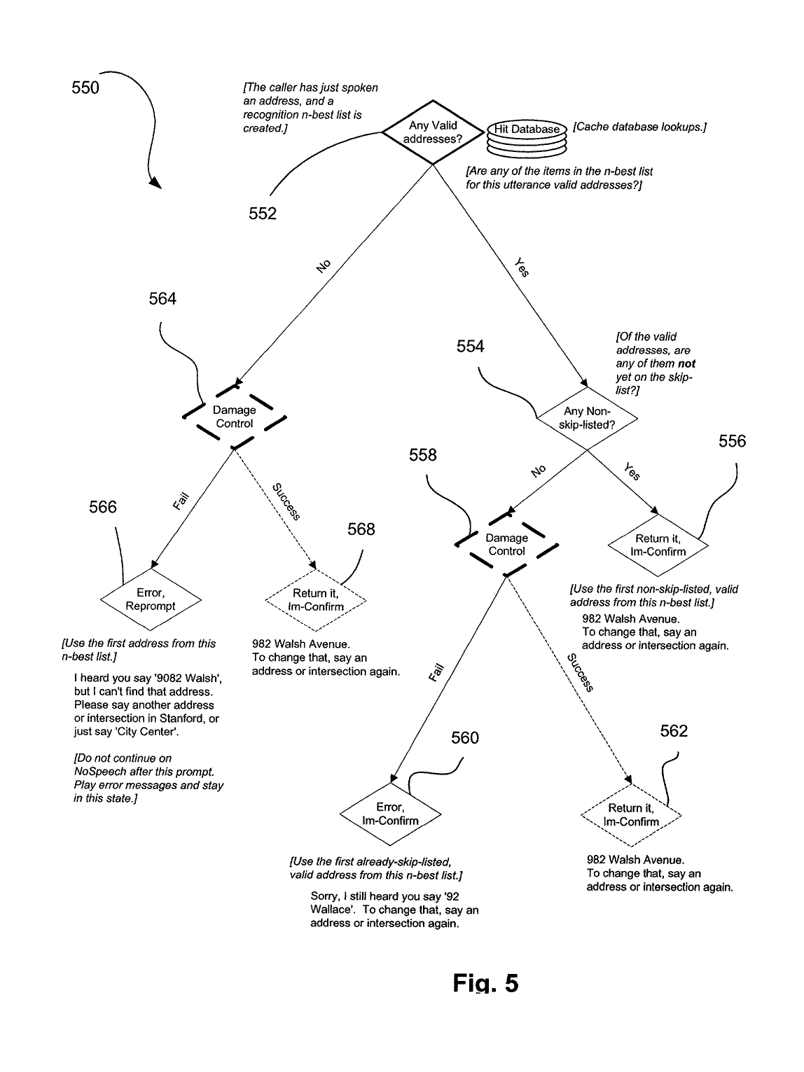

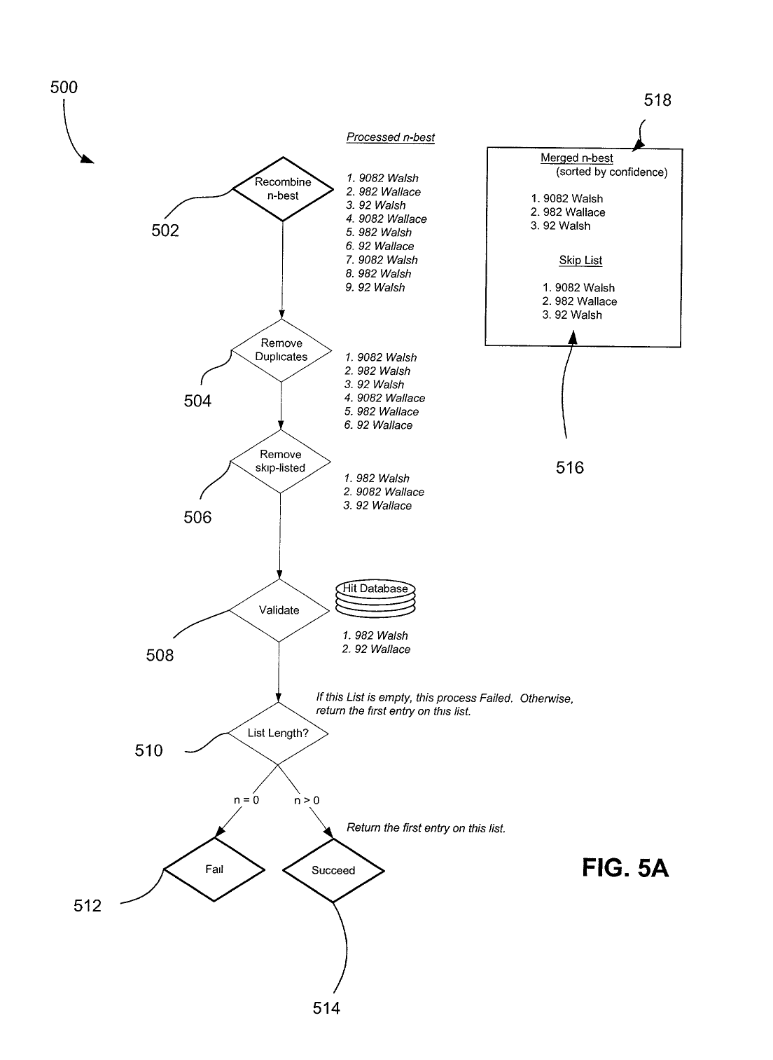

FIG. 5 illustrates a method 550 for recognizing utterances utilizing the database of grammars established in FIGS. 3 and 4. In one embodiment, the utterances may be received during a telephone call from the user. In such embodiment, the user may be seeking a particular service. In the context of the foregoing example wherein the database is populated with street names, the user may be using utterances to transmit an address, name, etc. for the purpose receiving verbal driving directions. It should be noted that the present invention is not limited to the use of a database of street names. Any variety of grammars may be used per the desires of the user.

During use of the present invention, an utterance is received which may be representative of at least a portion of an address. In response thereto, a plurality of potential speech recognition “hits” are produced in the form of a list. During operation 552, it is determined whether the addresses on the list are valid by comparing the same with the address database established in FIGS. 3 and 4. More information regarding such validation process will be set forth in greater detail during reference to operation 508 of FIG. 5A.

If it is determined that the address(es) are valid in operation 552, it is then determined in operation 554 whether the address was previously rejected. During use of the present invention, a user is capable of rejecting played back addresses. Such rejections may then be discarded and added to a “skip list.”

If such address is not present on such skip list in operation 554, the address may be played back again in operation 556. During such operation, the user may also be given an opportunity to reiterate the address. If such address is present on such skip list in operation 554, an intelligent damage control algorithm 558 may be executed which renders an error in operation 560 or a confirmation operation 562 which is similar to operation 556. In essence, the damage control algorithm 558 facilitates the avoidance of the undesirable error operation 560. More information regarding the damage control algorithm 558 will be set forth during reference to FIG. 5A.

Returning to operation 552, if there are no valid addresses, an intelligent damage control algorithm 564 may again be executed which renders an error in operation 566 or a confirmation operation 568. As shown, FIG. 5 further illustrates an exemplary dialog in response to a user who inputs the address “9082 Walsh.” Such example is continued in FIG. 5A.

FIG. 5A illustrates a method 500 for carrying out damage control when recognizing utterances during operations 558 and 564 of FIG. 5. As mentioned before, one or more utterances are received, where the components of the utterance may include a city and a state of the address, a street name and an address number of the address, streets of street intersection, and/or any other components of an address.

The method 500 of FIG. 5A aids users in getting an address recognized if there is trouble during the speech recognition process. To accomplish this, various grammars recognized from utterance components are combined to make intelligent guesses about what the user is saying.

After the utterances are received, matches are identified between each of the components of the utterance and grammars. There is usually more than one grammar that is matched for each utterance component, since commonly known recognizers are often unsure about what a person said for any given utterance. It is important to note that any type of speech recognition scheme may be used in the context of the present invention.

Then, in operation 502, each instance of a match of a first one of the components is combined with each instance of a match of a second one of the components to generate a plurality of grammar expressions. In particular, the matched grammars corresponding to the utterance components representative of the potential street address are combined to form each possible combination. In the case where the utterance components represent intersections, it should be noted that order is not relevant.

In operation 504, duplicate combinations of grammars (“grammar expressions”) may be discarded during the recognition process.

When the grammar expressions are outputted, a user is capable of rejecting the played back grammar expressions. Such rejected grammar expressions may then be discarded. It should be noted that previously discarded recognition results may also be discarded at this point. Note operation 506.

As an option, a score may be assigned to each of the grammar expressions. Specifically, each new grammar expressions (potential address) may be assigned a score based on a score of each of the components. This may be accomplished by simply taking the product of the scores of the components. It should be noted that the component scores are assigned to the components during the recognition process by gauging various recognition parameters.

Next, in operation 508, the results of the recognition process may be compared with the database of addresses mentioned hereinabove during reference to FIGS. 3 and 4. Various grammar expressions may then be discarded based on the comparison using the database of addresses. In particular, any recognized utterance (representative of the grammar expressions) that does not produce a match in the address database may be discarded.

Finally, in decision 510, it is determined whether any grammar expressions remain. If so, the method 500 is a success and the grammar expressions with the highest priority, as determined by the score, is outputted in operation 514. On the other hand, if there are no grammar expressions remaining, the method 500 is a failure, and a message may be outputted to the user. Note operation 512.

In still another embodiment of the present invention, results of the comparison of operation 508 may be cached for use when recognizing subsequent utterances. Such cache of addresses that have been loaded-up, and their respective validities may be stored. When checking a list of potential addresses, the cache may first be checked after which a map server may be consulted, thus avoiding the delay associated with the map server when possible. Cache entries may also expire at the end of the session from which they originated.

FIG. 5A also illustrates an example of operation of the present method 500. As shown, a first component of a received utterance is representative of an address number. The speech recognition scheme, in the present example, produces three (3) potential recognition grammars, i.e. 9082, 982, and 92. Further, a second component of the received utterance is representative of a street name in the present example. The speech recognition scheme produces two (2) potential recognition grammars, i.e. Walsh and Wallace. Such grammars are combined in every possible combination as indicated in operation 502 hereinabove. As shown, nine (9) grammar expressions are outputted.

Next, duplicate grammar expressions of grammars are removed, thus leaving only six (6) entries. See operation 504. Any of the grammar expressions that were previously skipped are subsequently removed. Note operation 506. It should be noted that a skip list 516 is maintained for comparing against the output of operation 504 to facilitate operation 506.

Subsequently, any of the grammar expressions outputted from operation 506 are compared against the database of addresses. Any grammar expressions that are representative of invalid addresses are removed. Note operation 508. Further, such resultant list of grammar expressions are compared against a merged n-best list 518 shown in FIG. 5A. Such comparison is used to prioritize any remaining grammar expressions based on the score set forth hereinabove. The remaining grammar expressions of the highest priority may then be outputted in operation 514.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for recognizing utterances, comprising:
(a) receiving an utterance including at least two components;
(b) identifying matches between each of the components of the utterance and grammars;
(c) combining each instance of a match of a first one of the components with each instance of a match of a second one of the components to generate a plurality of grammar expressions; and
(d) recognizing the received utterance utilizing the grammar expressions.

2. The method as recited in claim 1, and further comprising discarding duplicate grammar expressions.

3. The method as recited in claim 1, and further comprising assigning a score to each of the grammar expressions.

4. The method as recited in claim 3, and further comprising playing back the grammar expressions in a priority based on the score.

5. The method as recited in claim 3, wherein a score-based priority of the grammar expressions is stored in a list.

6. The method as recited in claim 1, and further comprising playing back the grammar expressions.

7. The method as recited in claim 6, wherein a user is capable of rejecting the played back grammar expressions.

8. The method as recited in claim 7, wherein the previously rejected grammar expressions are discarded.

9. The method as recited in claim 7, wherein the rejected grammar expressions are stored in a list.

10. The method as recited in claim 1, wherein the utterance is representative of at least a portion of an address.

11. The method as recited in claim 10, and further comprising comparing the grammar expressions with a database of addresses.

12. The method as recited in claim 11, wherein the grammar expressions are filtered based on the comparison using the database of addresses.

13. The method as recited in claim 12, and further comprising outputting the grammar expressions based on the comparison.

14. The method as recited in claim 10, wherein the components of the utterance include a city and a state of the address.

15. The method as recited in claim 10, wherein the components of the utterance include a street name and an address number of the address.

16. The method as recited in claim 10, wherein the components of the utterance include two street names describing an intersection.

17. The method as recited in claim 11, and further comprising caching results of the comparison.

18. The method as recited in claim 17, wherein the cached results are used for recognizing subsequent utterances.

19. A computer program product for recognizing utterances, comprising:
(a) computer code for receiving an utterance including at least two components;
(b) computer code for identifying matches between each of the components of the utterance and grammars;
(c) computer code for combining each instance of a match of a first one of the components with each instance of a match of a second one of the components to generate a plurality of grammar expressions; and
(d) computer code for recognizing the received utterance utilizing the grammar expressions.

20. A system for recognizing utterances, comprising:
(a) logic for receiving an utterance including at least two components;
(b) logic for identifying matches between each of the components of the utterance and grammars;
(c) logic for combining each instance of a match of a first one of the components with each instance of a match of a second one of the components to generate a plurality of grammar expressions; and
(d) logic for recognizing the received utterance utilizing the grammar expressions.

21. A method for recognizing utterances, comprising:
(a) receiving an utterance indicative of an address;
(b) recognizing the received utterance;
(c) comparing results of the recognition with a database of addresses; and
(d) discarding the results if the comparison fails.

22. A computer program product for recognizing utterances, comprising:
(a) computer code for receiving an utterance indicative of an address;
(b) computer code for recognizing the received utterance;
(c) computer code for comparing results of the recognition with a database of addresses; and
(d) computer code for discarding the results if the comparison fails.

23. A method for recognizing utterances, comprising:
(a) receiving an utterance including at least two components, wherein the utterance is indicative of content;
(b) identifying matches between each of the components of the utterance and grammars;
(c) combining each instance of a match of a first one of the components with each instance of a match of a second one of the components to generate a plurality of grammar expressions;
(d) scoring the grammar expressions;
(e) recognizing the received utterance utilizing the grammar expressions;
(f) comparing results of operation (e) with a database of the content; and
(g) discarding the results based on the score and the comparison.
